(19) United States
(12) Patent Application Publication
(10) Pub. No.: US 2019/0144319 A1
(43) Pub. Date: May 16, 2019

(54) SYSTEM FOR SANITIZING AND CLARIFYING WATER, AND RELATED COMPONENTS AND METHODS

(71) Applicant: Thermal Hydra Plastics LLC, Woodinville, WA (US)

(72) Inventor: James Luciano, Seattle, WA (US)

(21) Appl. No.: 16/165,990

(22) Filed: Oct. 19, 2018

Related U.S. Application Data
(60) Provisional application No. 62/574,555, filed on Oct. 19, 2017.

(51) Int. Cl. C02F 9/00; E04H 4/12; E04H 4/16

(52) U.S. Cl. CPC C02F 9/00; C02F 2103/42; E04H 4/16; E04H 4/1209

(57) ABSTRACT

A method for sanitizing and clarifying water includes: 1) pumping water through a filter component of a system, a conditioner component the system, an ionizer component of the system, a UV component of the system, and an ozone component of the system; 2) trapping particulates suspended in the water; 3) exposing the water to a magnetic field to polarize the water and promote clathrate formation in the water; 4) injecting metal ions into the water; 5) exposing the water to ultraviolet electromagnetic radiation; and 6) injecting ozone into the water.

### BACKGROUND

Traditional systems for sanitizing water, such as hot water used in a hot tub to relax one's muscles and mind, or a pool, or a swim spa, rely on chlorine and/or bromine to sanitize and clarify the water in the hot tub, pool or spa. These chemicals are very effective at killing bacteria in the water and breaking down organic waste contaminants from the bacteria and people using the hot tub, pool or spa. However, adding these chemicals to the water to treat the water has several drawbacks.

First, these chemicals can be harsh and damage one's skin as well as components of the hot tub, pool or spa that they contact, such as motors, heaters, and jets. Thus, using these chemicals requires one to constantly monitor the concentration of the chemicals in the water and maintain the concentration at a safe yet effective level. This is especially true during frequent use of the hot tub, pool or spa. This, in turn, imposes a substantial burden on the person running the hot tub, pool or spa and often results in the person neglecting his/her duties and the water in the hot tub, pool or spa becoming unbalanced and/or contaminated.

Thus, there is a need for a system that sanitizes and clarifies the water in a hot tub, pool or spa while minimizing the use of chemicals that can be harsh and damage one's skin as well as components of the hot tub, pool or spa.

### SUMMARY

In one aspect of the invention, a system for sanitizing and clarifying water includes a filter component, a conditioner component, an Ionizer component, a UV component, an ozone component, and a pump to move water through each of the components. The filter component includes a filter to trap particulates suspended in water when water flows through the filter. The conditioner component generates a magnetic field to polarize and promote clathrate formation in water when water flows through the conditioner component. The ionizer component includes an electrode that is positioned in water and injects metallic ions into the water when water flows past the electrode. The UV component generates ultraviolet electromagnetic radiation and exposes water to the ultraviolet electromagnetic radiation when water flows through the UV component. And, the ozone component injects ozone into water when water flows through the ozone component.

With the combination of the five components, the system sanitizes and clarifies water used in a hot tub, pool or spa, while minimizing the use of chemicals that can be harsh and damage one's skin as well as components of the hot tub, pool or spa. Because of this, one does not have to continually monitor the water processed by the system to make sure that the concentration of such harmful chemicals remains within a safe range. Thus, once the system is dialed in for the specific water used in the hot tub, pool and/or spa, and the correct frequency of use, the system may be set for continuous operation with intermittent monitoring of the water's quality by a person. The filter component traps particulates suspended in the water. The particulates can enter the water used in a hot tub, pool and/or spa, from people using the hot tub, pool and/or water. For example, particulates can include glitter and/or other types of make-up, sand and/or dirt. The conditioner component polarizes or organizes the water molecules by exposing the water to a magnetic field having a dense magnetic flux. This polarizing and organizing of the water molecules promotes the formation of clathrates which can help the filter component trap non-polar molecules (typically gases) and/or polar molecules with large hydrophobic portions. A clathrate is a cage formed from water molecules that surrounds and traps non-polar molecules and/or polar molecules with large hydrophobic portions, thus making the surrounded molecules larger and easier for the filter component to trap. And the ionizer, UV and ozone components each help kill bacteria and other organic micro-organisms.

In another aspect of the invention, a method for sanitizing and clarifying water includes: 1) pumping water through a filter component of a system, a conditioner component of the system, an ionizer component of the system, a UV component of the system, and an ozone component of the system; 2) trapping particulates suspended in the water; 3) exposing the water to a magnetic field to polarize the water and promote clathrate formation in the water; 4) injecting metal ions into the water; 5) exposing the water to ultraviolet electromagnetic radiation; and 6) injecting ozone into the water.

### BRIEF DESCRIPTION OF THE DRAWINGS

FIG. 1 shows a schematic view of a system for sanitizing and clarifying a fluid, according to an embodiment of the invention.

FIG. 2 shows a flow chart of the process that the system shown in FIG. 1 incorporates, according to an embodiment of the invention.

FIG. 3 shows a perspective view of a conditioner component included in the system shown in FIG. 1, according to an embodiment of the invention.

FIG. 4 shows a cross-sectional view of a filter component included in the system shown in FIG. 1, according to an embodiment of the invention.

FIG. 5 shows a perspective, cut-away view of an ionizer component included in the system shown in FIG. 1, according to an embodiment of the invention.

FIG. 6 shows a cross-sectional view of an ozone component and a UV component, each included in the system shown in FIG. 1, each according to an embodiment of the invention.

### DETAILED DESCRIPTION

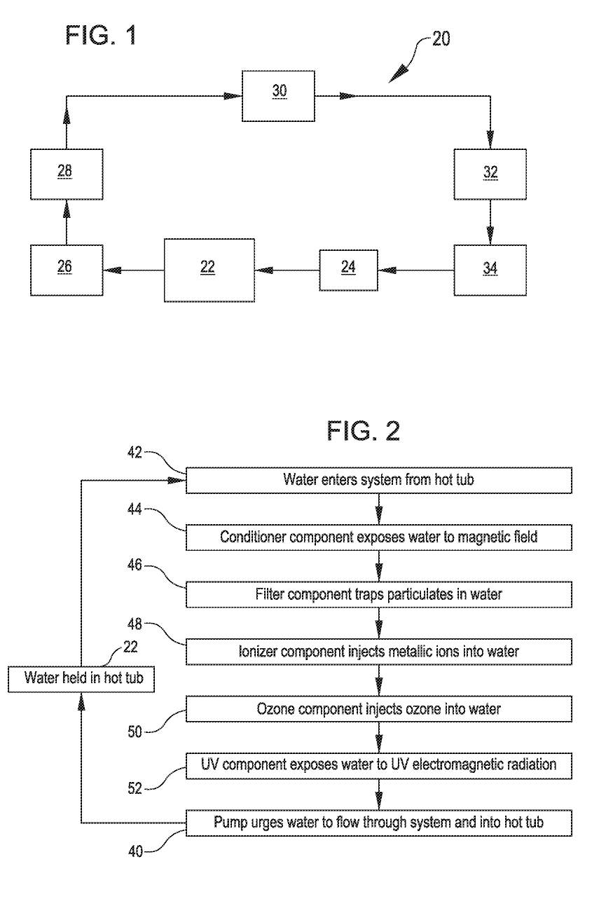

FIG. 1 shows a schematic view of a system 20 for sanitizing and clarifying a fluid, according to an embodiment of the invention. FIG. 2 shows a flow chart of the process that the system 20 incorporates, also according to an embodiment of the invention. The system 20 may be used to clean water that is used for any desired purpose, with none to a minimal amount of chemicals such as chlorine or bromine. Here, the system 20 is shown coupled to a hot tub 22 to sanitize and clarify water in the hot tub 22 that one soaks in to relax one's muscles and mind, but in other embodiments the system 20 may be coupled to a pool or swim spa. In addition, the system 20 may be used to sanitize and clarify any fluid containing unwanted particulates, organic matter, and/or bacteria.

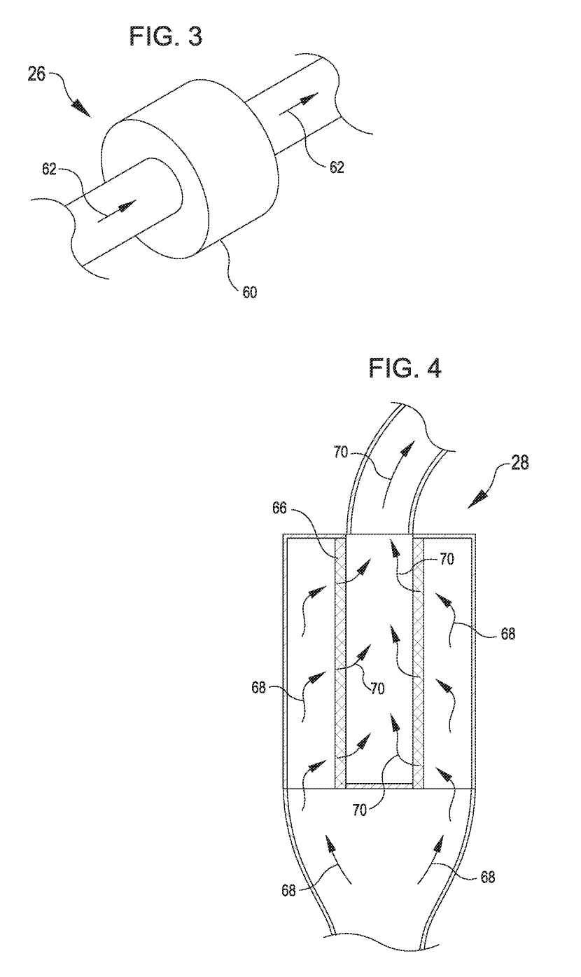

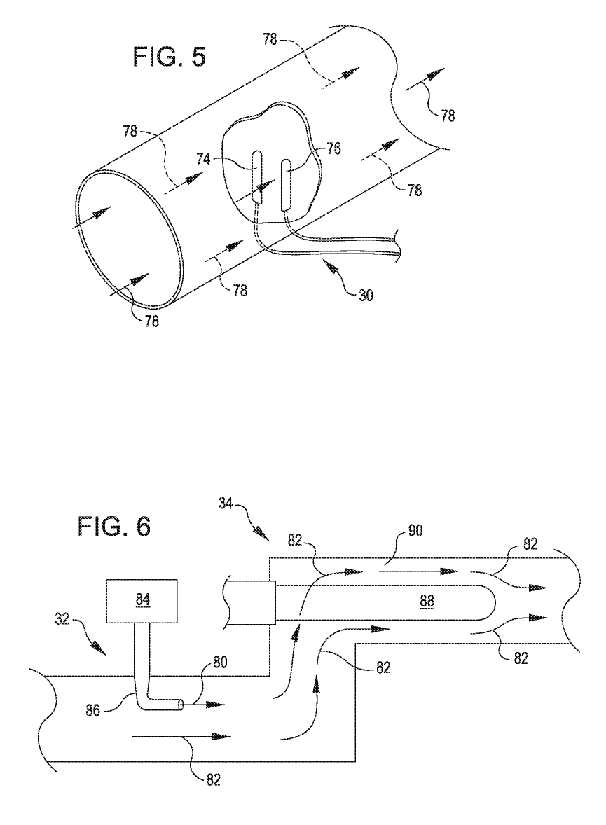

The system 20 includes a pump 24 that circulates the water held in the tub 22 through the system 20, a conditioner component 26, a filter component 28, an ionizer component 30, an ozone component 32, and a UV component 34. The conditioner component 26 (discussed in greater detail in conjunction with FIG. 3) generates a magnetic field to polarize and promote clathrate formation in water when water flows through the conditioner component 26. The conditioner component's magnetic field also gives the water a net positive (+) charge. The filter component 28 (discussed in greater detail in conjunction with FIG. 4) includes a filter to trap particulates suspended in water when water flows through the filter. In addition to making the water undesireable and/or unsafe for soaking in, the particulates can also damage, obstruct, and/or otherwise adversely affect the operation of the system's other components 24, 26, 30, 32 and 34. The ionizer component 30 (discussed in greater detail in conjunction with FIG. 5) includes an anode and a cathode that are positioned in water and inject metal ions into the water when water flows between the anode and cathode. The metal ions kill microorganisms such as algae, bacteria and viruses. The ozone component 32 (discussed in greater detail in conjunction with FIG. 6) injects ozone into the water that flows through it to kill microorganisms and help oxidize organic contaminants in the water. And, the UV component 34 (also discussed in greater detail in conjunction with FIG. 6) generates ultraviolet electromagnetic radiation and exposes water that flows through it to the ultraviolet electromagnetic radiation to also kill microorganisms in the water.

With the combination of the five components, the system 20 sanitizes and clarifies water used in the hot tub 22 while minimizing the use of chemicals that can be harsh and damage one's skin as well as components of the hot tub 22. Because of this, one does not have to continually monitor the water processed by the system 20 to make sure that the concentration of such harmful chemicals remains within a safe range. Thus, once the system 20 is dialed in for the specific water used, and the correct frequency of use, the system 20 may be set for continuous operation with less frequent monitoring of the water's quality.

The components 24, 26, 28, 32 and 34 of the system 20 may be arranged as desired to provide the system 20 with any desired process sequence. For example, as shown in FIGS. 1 and 2, in this and other embodiments, the pump 24 is located just upstream from the hot tub 22 and pulls the water in the hot tub 22 out of the tub 22 and through the other components 26, 28, 32 and 34 of the system 20. As shown at step 40 in FIG. 2, after the water leaves the last component 34, the water flows through the pump 24 and into the hot tub 22. This provides maximum protection for the pump 24 and its components because the pump 24 and its components are exposed to sanitized and clarified water, not the unclean water that the components 26, 28, 32 and 34 sanitize and clarify. The process sequence for the system 20 begins at step 42 in FIG. 2 with water flowing from the hot tub 22 to the conditioner component 26. At step 44 of FIG. 2, water then flows through the magnetic field generated by the conditioner component 26, and to the filter component 28. At step 46 of FIG. 2, the water then flows through the filter component 28 and to the ionizer component 30. At step 48 of FIG. 2, the water then flows through the ionizer component 30 and to the ozone component 32. At step 50 of FIG. 2, the water then flows through the ozone component 32 and to the UV component 34. At step 52 of FIG. 2, the water then flows through the UV component 34 and to the pump 24.

By arranging the components in this order, the system 20 can sanitize and clarify the water from the hot tub 22 in an efficient and inexpensive manner. Having the water flow through the conditioner component 26 before flowing through the filer component 28 allows the clathrates that form and capture the non-polar molecules and/or polar molecules with large hydrophobic portions to be trapped by the filter component 28 and removed from the water. And having ozone injected into the water before exposing the water to ultraviolet electromagnetic radiation allows some of the radiation to help the ozone generate hydroxyl radicals (.OH), which are strong oxidizers. Moreover, having the water flow through the ozone and UV components 32 and 34 at the end of the system's process allows one to minimize the amount of ozone injected into the water, and thus minimize the system's consumption of ozone.

Other embodiments are possible. For example, the first component that the water flows through may be the filter component 28, followed by the conditioner component 26, then the pump 24, then the ionizer component 30, then the ozone component 32, and finally the UV component 34. For another example, the system 20 may include two or more subsystems that operate parallel with each other relative to the hot tub 22. In such embodiments, each subsystem may include its own pump and may include its own set of components that may have one or more of the following—a conditioner component 26, a filter component 28, an ionizer component 30, an ozone component 32, and a UV component 34.

Still referring to FIG. 1, the pump 24 draws water out of the hot tub 22, directs the water through the components 26, 28, 30, 32, and 34 of the system, and then returns the sanitized and clarified water back to the tub 22. To do this the pump 24 may be any desired pump that moves a desired amount of water in a desired amount of time. For example, in this and other embodiments, the pump 24 is a conventional circulation pump designed for continuous operation with a flow rate that results in all of the water in the hot tub 22 flowing through the system 20 within six hours. To do this specifically, the pump 24 generates a flow of water of about two-and-a-half gallons per minute and that has a pressure of about four pounds-per-square-inch (psi). With these flow numbers the pump 24 can make one complete turnover of all of the water typical hot tub that contains 400 gallons in a little under three hours. Such a circulation rate allows the components 26, 28, 30, 32, and 34 ample time to efficiently operate and keep all of the water sanitized and clarified under normal use conditions. In addition, the pump 22 may include control circuitry to allow one to automatically or manually increase the flow rate and/or pressure to correspond with specific elements, such as minerals or other molecules, contained in the water being used in the hot tub 22 and/or the frequency at which the hot tub 22 is used.

Other embodiments are possible. For example, the pump 24 may be capable of generating a high flow rate with a large amount pressure, so that the sanitized and clarified water may be injected back into the hut tub 22 via nozzles or jets.

FIG. 3 shows a perspective view of a conditioner component 26 included in the system shown in FIG. 1, according to an embodiment of the invention. The conditioner component 26 polarizes or organizes the water molecules by exposing the water to a magnetic field whose magnetic flux is dense. Polarizing and organizing the water molecules promotes the formation of clathrates which can help the filter component trap non-polar molecules (typically gases) and/or polar molecules with large hydrophobic portions. A clathrate is a cage formed from water molecules that surrounds and traps non-polar molecules and/or polar molecules with large hydrophobic portions, thus making the surrounded molecules larger and easier for the filter component 28 (FIG. 1) to trap. Polarizing and organizing the water molecules also gives the water a net positive charge, which reduces eye and skin irritation, chemical odors, and makes the water feel better on one's skin.

The conditioner component 26 may include any desired component capable of generating a magnetic field having a dense magnetic flux. For example, in this and other embodiments the conditioner component 26 includes a permanent magnet 60 that generates a magnetic field having a magnetic flux of at least 3,800 Gausses or 0.38 Teslas. More specifically, the permanent magnet 60 surrounds the water 62 flowing through the system 20, and includes a ceramic material that generates a magnetic flux of 4,300 Gausses or 0.43 Teslas. The ceramic material may be strontium or barium ferrite. In other embodiments, the permanent magnet 60 includes a rare-earth material, such as samarium-cobalt and neodymium-iron-boron.

Other embodiments are possible. For example, the conditioner component 26 may include an electromagnet in addition to or in lieu of the permanent magnet 60. For another example, the conditioner component 26 may include two or more permanent magnets 60. In addition, the permanent magnet 60 may not surround the water that flows through the conditioner component 26.

FIG. 4 shows a cross-sectional view of a filter component 28 included in the system shown in FIG. 1, according to an embodiment of the invention. The filter component 28 traps particulates suspended in the water. The particulates can enter the water used in a hot tub, pool and/or spa, from people using the hot tub, pool and/or water and often include organic matter as well as nonorganic matter such as make-up, sand and/or dirt.

The filter component 28 may include any desired filter capable of trapping particulates suspended in the water and other objects. For example, in this and other embodiments, the filter component 28 includes a conventional cartridge filter 66 that is in the shape of a cylinder and includes many pleats to increase the surface of the filter media that is exposed to the unclean water. The filter media of the cartridge filter 66 is configured to prevent, and thus trap, particulates whose size is five microns or greater, while allowing the water to flow through the media. In operation, unclean water 68 enters the filter component 28, flows around the outside of the cartridge filter 66, and then toward the cartridge filter 66. The water then flows through the cartridge filter 66 toward the interior of the cartridge filter 66 and then exits the filter component 28. As the water flows through the cartridge filter 66, the media traps the particulates in the unclean water 68 and allows clean water 70 to flow toward the ionizer component 30 of the system 20.

Other embodiments are possible. For example, the filter component 28 may include two or more cartridge filters 66 arranged in series or parallel with each other. For another example, the filter component 28 may include a filter other than a cartridge filter 66, such as a reverse-osmosis filter that includes a semi-permeable membrane to trap unwanted particulates and molecules. With a reverse-osmosis filter one can trap particulates as small as 0.001 microns, but typically has to operate the filter parallel to the main flow of water through the system 20. In other words, with a reverse-osmosis filter one can divert some of the water flowing through system 20, clean it, and then insert it back into the main flow of water through the system 20.

FIG. 5 shows a perspective, cut-away view of an ionizer component 30 included in the system shown in FIG. 1, according to an embodiment of the invention. The ionizer component 30 injects metal ions into the water that kill microorganisms such as algae, bacteria and viruses.

The ionizer component 30 may be configured as desired to inject metal ions into the water. For example, in this and other embodiments the ionizer component 30 includes a first electrode 74 and a second electrode 76 that each generate and disperse metal ions into the water 78 flowing past them while they are energized with electricity. While electrical current flows through the first electrode 74, the electrode 74 generates and disperses copper ions into the water 78. Likewise, while electrical current flows through the second electrode 76, the electrode 76 generates and disperses silver ions into the water 78. The number of ions that each electrode generates depends on the amount of electrical current flowing through each electrode 74 and 76. Thus, for a set electric current, the number of ions dispersed into the water depends on the length of time that the electric current flows through the anodes. The longer the period, the greater the number of ions that are generated, and thus dispersed. The shorter the period, the fewer the number of ions that are generated, and thus dispersed. For good results, the amount of copper and silver ions in the water 78 should be between 0.20 and 0.4 parts per million. To control the number of ions generated and dispersed, the ionizer component 30 includes control circuitry (not shown) that allows one to control the period during which each of the electrodes 74 and 76 are energized.

Other embodiments are possible. For example, the ionizer component 30 may generate a single type of metal ions, not two, and the single type may be copper ion, silver ions, or any other metal ions. For another example, the ionizer component 30 may generate more than two types metal ions. In addition, the ionizer component 30 may include more than one electrode for each type of metal generated. This would allow one to generate a large amount of metal ions in a short period in response to the water 78 being heavily contaminated by very frequent use or an inadvertent spill into the water 78.

FIG. 6 shows a cross-sectional view of an ozone component 32 and a UV component 34, each included in the system 20 shown in FIG. 1, each according to an embodiment of the invention. The ozone component 32 injects ozone 80 into the water 82 that flows through it to kill microorganisms and help oxidize organic contaminants in the water. The UV component 34 generates ultraviolet electromagnetic radiation and exposes water that flows through it to the ultraviolet electromagnetic radiation to also kill microorganisms in the water.

The ozone component 32 may be configured as desired to inject ozone (O₃) into the water 82 that flows through the ozone component 32. For example, in this and other embodiments the ozone component 32 includes an ozone generator 84 coupled to an injector 86. The ozone generator 84 generates ozone by applying a voltage across a dielectric discharge gap that contains oxygen-bearing gas. The ozone is then directed to the injector 86 that injects the ozone into the water 82 at a rate of about 50 to 100 milligrams per hour. Dissolved in the water 82, the ozone oxidizes microorganisms and organic contaminants in the water 82 causing damage to a cell's walls, a cell's nucleic acids, and carbon-nitrogen bonds which leads to depolymerization. Ozone also oxidizes soap, deodorant, hair spray, cologne, makeup, perfume, body lotion, hand cream, sun tan lotion, saliva, and urine.

Other embodiments are possible. For example, the ozone component 32 may also inject hydrogen peroxide (H₂O₂), which is a strong oxidizer, and via a simple reaction can generate hydroxyl radicals (.OH). For another example, the ozone component 32 may include two or more injectors 86.

The UV component 34 may be configured as desired to generate electromagnetic radiation in the ultraviolet spectrum (UV light) and expose the water 82 flowing through the component 34 to the UV light. For example, in this and other embodiments the UV component 34 includes a light bulb 88, comparable to a fluorescent bulb, that generates light at a wavelength of about 254 nanometers located in a chamber 90 through which the water 82 flows. UV light has no effect on pH or color and has little effect on the chemical composition of the water 82. But, UV light is effective at eliminating microorganisms. The UV light radiated by the bulb attacks the DNA and RNA of microorganisms and either kills the microorganism or prevents it from multiplying.

Other embodiments are possible. For example, the UV component may include a light bulb that generates electromagnetic radiation having a wavelength other than about 254 nanometers. For another example, the UV component 34 may include two or more light bulbs that generate electromagnetic radiation in the ultraviolet spectrum.

In this and other embodiments, the ozone component 32 and the UV component 34 are adjacent each other with the ozone component 32 just upstream from the UV component 34. This allows the two components to combine their functions and provide an advanced oxidation process (AOP). AOP is a process that generates hydroxy radicals (.OH) in the water and includes a number of chemical processes that use ozone, hydrogen peroxide, and/or UV light to generate the hydroxyl radical. In other embodiments, the two components 32 and 34 may not be located adjacent each other.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A system for sanitizing and clarifying water, the system comprising:
a filter component that includes a filter operable to trap particulates suspended in water when the water flows through the filter;
a conditioner component operable to generate a magnetic field to polarize and promote clathrate formation in water when the water flows through the conditioner component;
an ionizer component that includes an electrode positionable in water and operable to inject metal ions into the water when the water flows past the electrode;
a UV component operable to generate ultraviolet electromagnetic radiation and expose water to the ultraviolet electromagnetic radiation when the water flows through the UV component;
an ozone component operable to inject ozone into water when the water flows through the ozone component; and
a pump operable to move water through each of the filter component, the conditioner component, the ionizer component, the UV component, and the ozone component.

2. The system of claim 1 wherein the filter of the filter component is configured to trap particulates whose size is five microns or greater.

3. The system of claim 1 wherein the filter of the filter component is configured to trap clathrates formed by the conditioner component.

4. The system of claim 1 wherein the conditioner component includes a permanent magnet that generates a magnetic field having a magnetic flux density of 4,300 Gausses or 0.43 Teslas.

5. The system of claim 1 wherein the conditioner component includes a permanent magnet that surrounds the water when the water flows through the conditioner component.

6. The system of claim 1 wherein the ionizer component is operable to generate a copper ion.

7. The system of claim 1 wherein the ionizer component is operable to generate and inject copper ions at a rate that provides a quantity of ions between 0.20 and 0.4 parts per million.

8. The system of claim 1 wherein the ionizer component is operable to generate a silver ion.

9. The system of claim 1 wherein the UV component is operable to generate UV electromagnetic radiation having a wavelength between 200 and 280 nanometers.

10. The system of claim 1 wherein the ozone component is operable to generate ozone.

11. The system of claim 1 wherein the ozone component is operable to inject ozone at a rate between 50 and 100 milligrams per hour.

12. The system of claim 1 wherein the pump is operable to move water at a rate of two-and-half gallons per minute.

13. A spa comprising:
a hot tub operable to hold water; and
a system operable to sanitize and clarify water held in the hot tub, the system including:
a filter component that includes a filter operable to trap particulates suspended in the water;
a conditioner component operable to generate a magnetic field to polarize and promote clathrate formation in the water;
an ionizer component that includes an anode and a cathode positionable in the water and operable to inject metallic ions into the water;
a UV component operable to generate ultraviolet electromagnetic radiation and expose the water to the ultraviolet electromagnetic radiation;
an ozone component operable to inject ozone into the water; and
a pump operable to move the water through each of the filter component, the conditioner component, the ionizer component, the UV component, and the ozone component.

14. A method for sanitizing and clarifying water, the method comprising:
pumping water through a filter component of a system, a conditioner component of the system, an ionizer component of the system, a UV component of the system, and an ozone component of the system;
trapping particulates suspended in the water;
exposing the water to a magnetic field to polarize the water and promote clathrate formation in the water;
injecting metal ions into the water;
exposing the water to ultraviolet electromagnetic radiation; and
injecting ozone into the water.

16. The method of claim 14 wherein exposing the water to the magnetic field occurs before trapping particulates suspended in the water.

17. The method of claim 14 wherein pumping the water through the components includes pulling the water through each of the components.

18. The method of claim 14 wherein trapping particulates suspended in the water includes moving the water through a mesh that is sized to block particulates that are at least five microns in size.

19. The method of claim 14 wherein exposing the water to a magnetic field includes surrounding the water with a permanent magnet that generates a magnetic field that has magnetic flux density of 0.43 Teslas.

20. The method of claim 14 wherein injecting metal ions into the water includes injecting copper ions into the water.

21. The method of claim 14 wherein injecting metal ions into the water includes injecting silver ions into the water.

22. The method of claim 14 wherein injecting metal ions into the water includes positioning an electrode in the water.

23. The method of claim 14 wherein exposing the water to UV electromagnetic radiation includes generating UV electromagnetic radiation having a wavelength between 200 and 280 nanometers.

24. The method of claim 14 wherein injecting ozone into the water includes injecting ozone at rate of 50 to 100 milligrams per hour.

25. The method of claim 14 wherein injecting ozone into the water includes generating the ozone.
